(19) United States
(12) Patent Application Publication
(10) Pub. No.: US 2008/0015952 A1
(43) Pub. Date: Jan. 17, 2008

(54) DRAG AND DROP SELECTION OF PRODUCTS

(76) Inventors: Jonathan William Medved, Jerusalem (IL); Ariel Yehoshua Kahan, Jerusalem (IL)

Correspondence Address: DANIEL J SWIRSKY, 55 REUVEN ST., BEIT SHEMESH, 99544, omitted

(21) Appl. No.: 11/772,873

(22) Filed: Jul. 3, 2007

Related U.S. Application Data
(60) Provisional application No. 60/819,643, filed on Jul. 11, 2006.

(51) Int. Cl. G06Q 30/00

(52) U.S. Cl. 705/27

(57) ABSTRACT

A method includes enabling a user to drag and drop an item presented on a webpage from a location on the webpage of a public collection to a location on the webpage of a personal collection of the user and requesting purchasing information from the user after the item is dropped into the private collection. The method also includes enabling the user to drag and drop the item from the personal collection to a distribution area for a labeled shipping address. The method also includes a drag and drop from the public collection to the distribution area.

### CROSS-REFERENCE TO RELATED APPLICATIONS

This application claims benefit from U.S. Provisional Patent Application 60/819,643, filed Jul. 11, 2006, which is hereby incorporated in its entirety by reference.

### FIELD OF THE INVENTION

The present invention relates to shared personalization content generally.

### BACKGROUND OF THE INVENTION

FIG. 1, to which reference is now made, illustrates a media content sharing system 100 described in prior patent applications U.S. 60/771,883 and 60/772,564, now incorporated into U.S. patent application Ser. No. 11/544,938, which applications are assigned to the common assignee of the present application and are hereby incorporated by reference.

FIG. 1 shows a communication device 110, owned by, for example, Jack, and a telephone 120, owned by, for example, Jill, who are simultaneously setting up or using a voice connection 140 for a telephone conversation. Jack and Jill are members of a content sharing community 150 and use a community server 130 for the selection and download of content, such as media clips (which may include video clips, audio clips, etc.), to be played on communication device 1 10. In the example, Jack and Jill are also “buddies”, members of community 150 who elect to share content with each other.

Community server 130 comprises a media clip selection database 132 which stores a collection of media clips 134 for selection by members of community 150. Jill accesses community server 130 via an Internet connection (arrow 131) and then selects a media clip 134 for her video ringtone.

A software client (not shown) on Jack's communication device 110 then downloads (arrow 133) Jill's media clip 134 to device 110. Communication device 110 comprises a media player 112, a personalization content manager 137, and buddy media clip database 138. Buddy media clip database 138 comprises media clips 136 which are copied versions of media clips 134 selected by Jack's buddies.

When Jill initiates a voice connection 140 from telephone 120 to Jack's communication device 110, personalization content manager 137 identifies her as one of Jack's buddies. Personalization content manager 137 then retrieves the media clip 136 originally selected by Jill and plays it as a video ringtone on media player 112, thus playing Jill's selected clip on Jack's phone when Jill calls.

Community 150 is also used in a similar manner to download other variations of video ringtones. For example, Jill can select a media clip 134 for a video ringback tone as well. After the selected media clip 134 is downloaded to Jack's device 110, it can be played as a video ringback tone when he calls Jill. U.S. Patent applications 60/771,883 and 60/772,564 also describe how community 150 can be used in a similar manner to select and distribute “ringbye tones” which are played at the end of a phone conversation and other tones.

### SUMMARY OF THE PRESENT INVENTION

There is provided, in accordance with a preferred embodiment of the present invention, a method including enabling a user to drag and drop an item presented on a webpage from a location on the webpage of a public collection to a location on the webpage of a personal collection of the user and requesting purchasing information from the user after the item is dropped into the private collection.

Additionally, in accordance with a preferred embodiment of the present invention, the item is a media clip and, in accordance with a preferred embodiment of the present invention, the media clip is shared personalization content.

Further, in accordance with a preferred embodiment of the present invention, the webpage is associated with an on-line store.

Still further, in accordance with a preferred embodiment of the present invention, the method includes enabling the user to drag and drop the item from the personal collection to a distribution area associated with a selected buddy of the user and distributing the item to the selected buddy.

Additionally, in accordance with a preferred embodiment of the present invention, the item is an item to be purchased and the method also includes enabling the user to drag and drop the item from the personal collection to a distribution area for a labeled shipping address.

Moreover, there is provided, in accordance with a preferred embodiment of the present invention, a method including having at least one buddy area of a webpage, the buddy area having a distribution area associated with it, enabling a user to drag and drop an item from a location on the webpage of a personal collection of the user to the distribution area of a selected buddy of the user and distributing the item to the selected buddy.

Additionally, in accordance with a preferred embodiment of the present invention, the item is a media clip and the distributing is to a communication device of the buddy.

Alternatively, in accordance with a preferred embodiment of the present invention, the item is an item to be purchased and the distribution area is associated with a shipping address of the buddy.

There is also provided, in accordance with a preferred embodiment of the present invention, a web server including a web-based application and a purchasing application. The web-based application presents items in a public collection area and enables a user to drag and drop an item from the public collection to a location on the webpage of a personal collection of the user. The purchasing application requests purchasing information from the user after the item is dropped into the private collection.

Moreover, in accordance with a preferred embodiment of the present invention, the item is a media clip. The media clip may be shared personalization content.

Further, in accordance with a preferred embodiment of the present invention, the webpage may be associated with an on-line store.

Additionally, in accordance with a preferred embodiment of the present invention, the web-based application also includes a shipping application to enable the user to drag and drop the item from the personal collection to a distribution area for a buddy.

Further, in accordance with a preferred embodiment of the present invention, the item is a media clip and the shipping application includes a unit for distributing the media clip to a communication device of the buddy.

Still further, in accordance with a preferred embodiment of the present invention, the item is an item to be purchased and the distribution area is associated with a shipping address of the buddy.

There is also provided, in accordance with a preferred embodiment of the present invention, a server including a web-based application and a distribution application. The web-based application enables a user to drag and drop an item from a location on a webpage of a personal collection of the user to a distribution area of a selected buddy of the user. The distribution application distributes the item to the buddy.

Additionally, in accordance with a preferred embodiment of the present invention, the item is a media clip and the distribution application includes a unit to send the media clip to a communication device of the buddy.

Moreover, in accordance with a preferred embodiment of the present invention, the item is an item to be purchased and the distribution application includes a unit to send the item to a mailing address of the buddy.

There is also provided, in accordance with a preferred embodiment of the present invention, a method including having at least one buddy area of a webpage, the buddy area having a distribution area associated with it, enabling a user to drag and drop an item, such as described hereinabove, from a location on the webpage of a public collection to the distribution area of a selected buddy of the user and distributing the item to the selected buddy.

Additionally, in accordance with a preferred embodiment of the present invention, the method includes purchasing the item after dropping it into the distribution area.

Finally, there is also provided, in accordance with a preferred embodiment of the present invention, a server including a web-based application and a distribution application. The web-based application enables a user to drag and drop an item from a location on a webpage of a public collection to a distribution area of a selected buddy of the user. The distribution application distributes the item to the buddy.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a media content sharing system for the selection and distribution of media content, such as video ringtones;

FIG. 2 is a schematic illustration of a webpage on a community server of the system of FIG. 1;

FIGS. 3A, 3B and 3C are schematic illustrations of selection and purchasing operations performed on the webpage of FIG. 2;

FIG. 4 is a schematic illustration of distribution operations performed on the webpage of FIG. 2; and

FIG. 5 is a schematic illustration of a webpage for an on-line store.

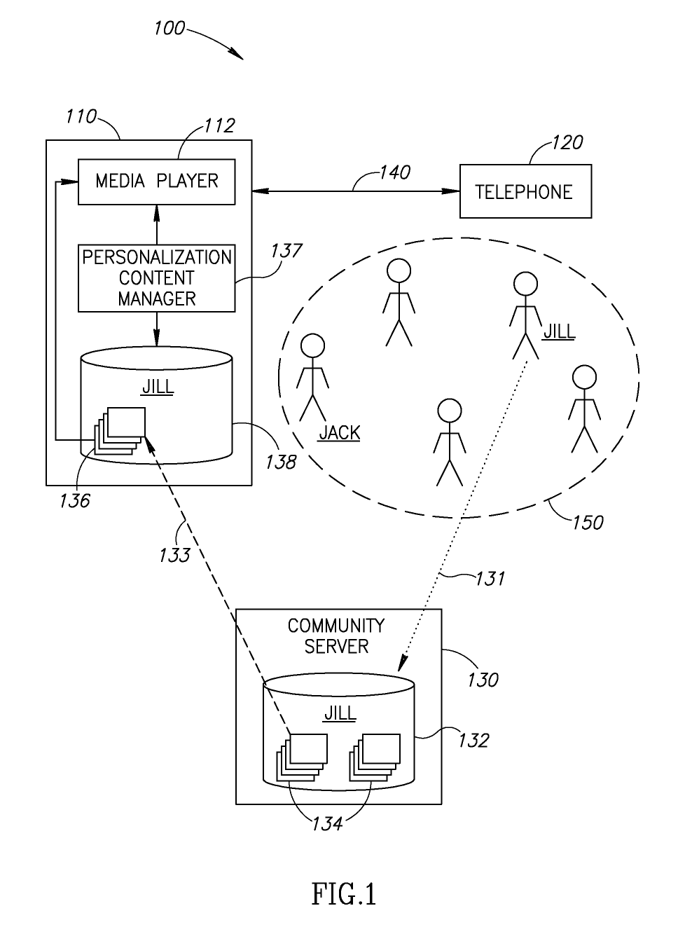

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

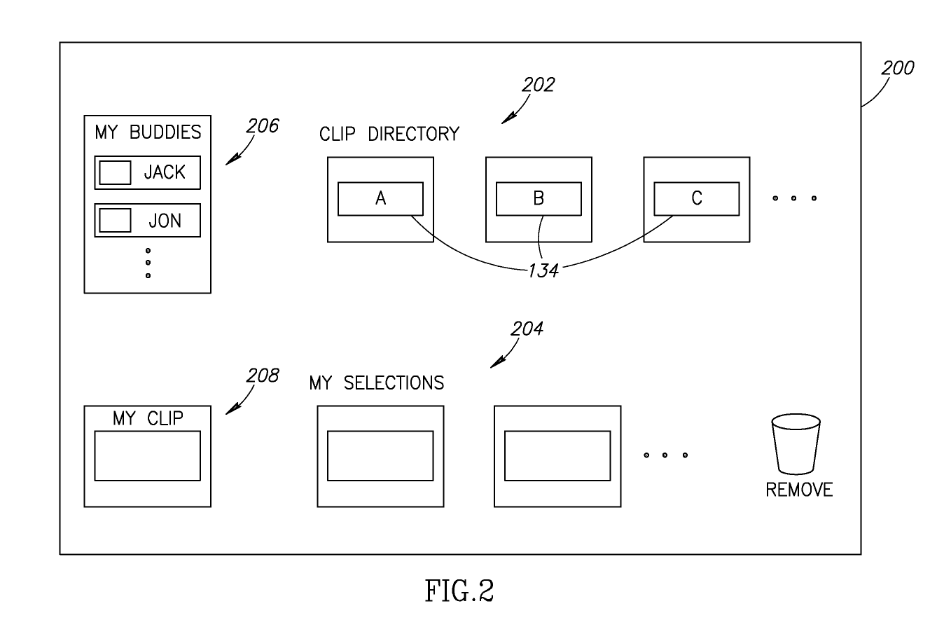

The present invention may be a novel method enabling users to select their media clips. Reference is now made to FIG. 2, which illustrates an exemplary main webpage 200 associated with community server 130. Webpage 200 may be accessible from any type of computing platform which may have an Internet browser. Thus, a user may access webpage 200 from a personal computer, an Internet-enabled telephone and/or an Internet-enabled personal digital assistant (PDA). For each of these, the Internet browser may communicate with community server 130 which runs webpage 200.

Webpage 200 may be divided into a media clip directory 202, a user's personal collection area 204, a buddies area 206 and a personal clip area 208. Directory 202 may show various media clips 134 available for selection. Clips 134 may be user-generated or may be portions of movies, trailers, television shows, animations, advertisements, games, puzzles, etc. They may be free or for-sale. In directory 202, media clips 134 may each repeatedly run silently, showing the user the action of the clip.

Collection area 204 may be used to store the media clips which the user has selected. Buddies area 206 may list the buddies of the user. For this example, Jill is the user and two buddies, Jack and Jon, are listed. Personal clip area 208 may store the media clip that the user, Jill, has selected as her clip (i.e. as the default clip her buddies see when they call her or when she calls them).

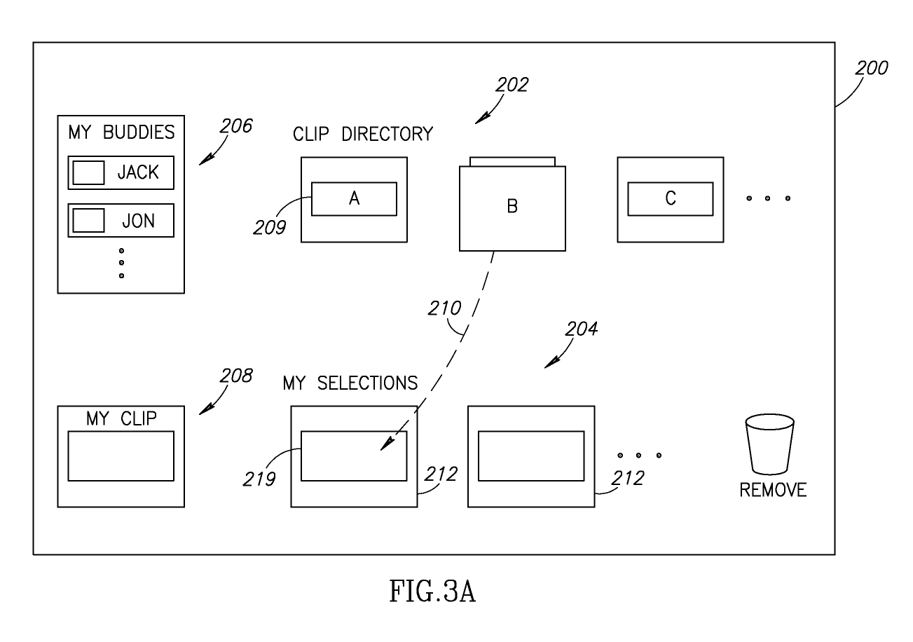

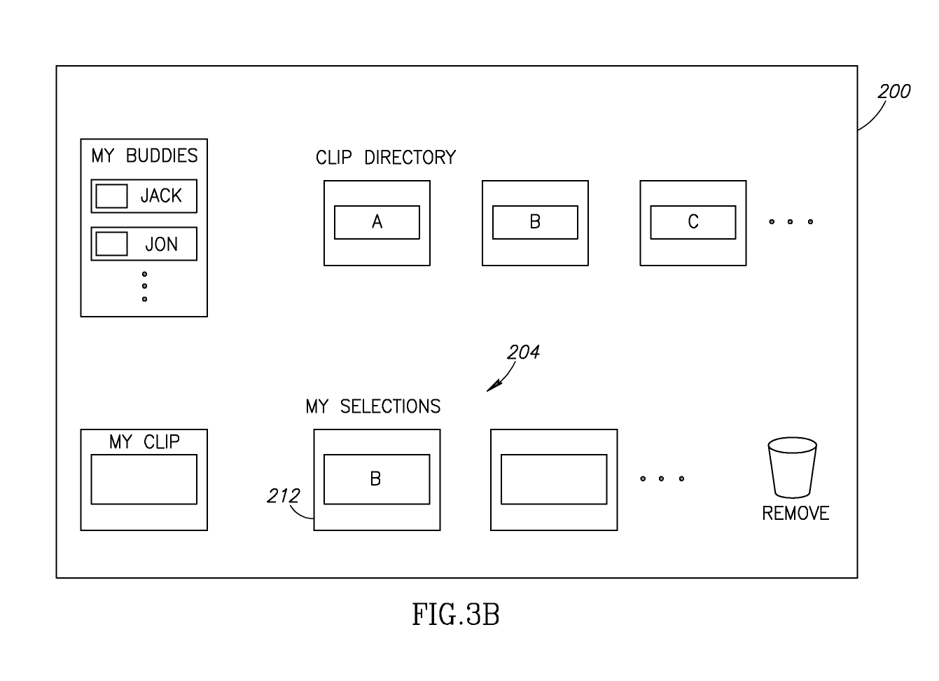

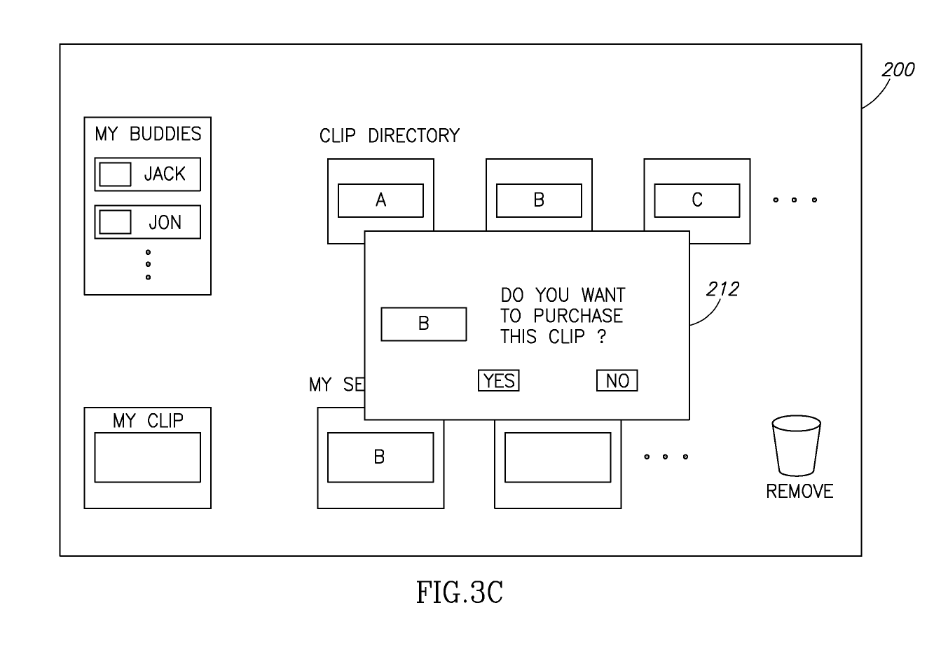

Reference is now made to FIGS. 3A, 3B and 3C, which, together, illustrate a drag-and-drop method for selecting and/or purchasing media clips 134. When Jill, the user, is interested in a clip in directory 202, she may click, such as with a mouse button or other cursor button, on a screen area 209 of the clip. As a result, the application driving webpage 200 may enlarge the window or screen area for the selected clip, near the current cursor location, and may play the clip, possibly with sound, in the enlarged window or screen area. Thus, by clicking on a clip 134, Jill may watch the clip in full. In the example of FIG. 3A, Jill clicked on clip B and thus, clip B is enlarged.

Should Jill be uninterested in the clip, she may either click again on the cursor button or may release the held cursor button. In response to either action, the application driving webpage 200 may return the clip to its display area 209. On the other hand, should Jill want the clip for her collection, she may drag, as indicated by arrow 210, the clip to collection area 204. Such dragging typically involves moving the cursor device while holding down the relevant cursor button. Alternatively, Jill may just move the cursor device and may click a second time, over collection area 204, to drop the clip.

When Jill drops selected clip B into collection area 204, the application driving webpage 200 may select an empty storage area 212 of collection area 204, may reduce selected clip B to fit a screen area 219 of storage area 212 and may stop playing the sound of the clip. FIG. 3B shows clip B dropped into collection area 204.

Upon dropping selected clip B or when selected clip B is over a large portion of one screen area 219 in collection area 204, the application driving webpage 200 may provide a dialog box 220 (FIG. 3C), asking Jill if she wants to buy selected clip B. If Jill replies YES, then the application may activate a purchasing application. The latter may drive one or more web pages which Jill may fill in and/or activate. If the user replies NO to dialog box 220, the application may remove selected clip B from collection area 204.

Alternatively, selected clip B may not require purchasing. If so, selected clip B may be dropped into screen area 212 without dialog box 220 appearing.

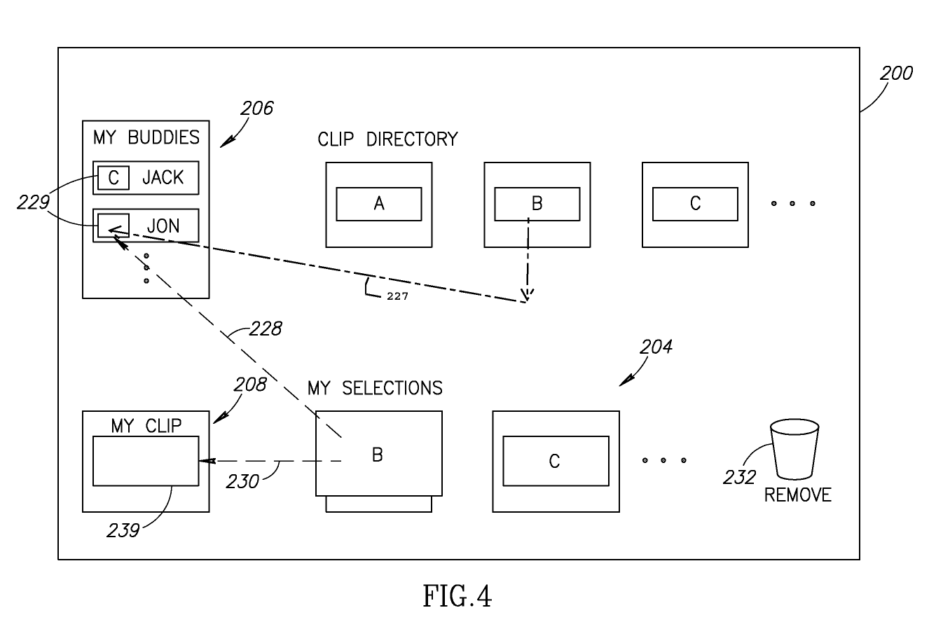

Reference is now made to FIG. 4, which illustrates a drag-and-drop method for distributing selected and/or purchased media clips, such as clip B. In accordance with a preferred embodiment of the present invention, the application driving webpage 200 may provide a similar drag-and-drop mechanism to enable users, such as Jill, to distribute clips from her collection to her buddies and/or for herself.

For example, Jill may want to share clip B with her buddy Jon. Jon may be listed in buddies area 206, along with other buddies, like Jack. Next to each buddy name, there may be a screen area 229, which may initially be empty.

To share a clip, Jill may click on clip B in her collection area 204 and may drag it (arrow 228) to the screen area 229 associated with Jon. Dropping clip B onto the screen area 229 associated with Jon may associate clip B with Jon. As a result, Jon may see clip B whenever Jon and Jill call one another. FIG. 4 shows that Jill has selected clip C as well and previously associated it with her buddy Jack.

Once Jill has associated clips B and C with her buddies Jack and Jon, community server 130 may distribute clips B and C, at any appropriate time, to the telephones or other devices of Jack and Jon, as discussed in patent applications U.S. 60/771,883 and 60/772,564, now incorporated into U.S. patent application Ser. No. 11/544,938.

Jill may change her selections at any time. She may drag and drop new clips to screens 229 of her buddies. Upon dropping, the new clips will become the currently associated clips of her buddies, to be distributed at the appropriate times.

Jill may also choose a default clip for herself, to use with buddies for whom she has not yet associated a clip or which she wants to see when someone who is not her buddy, an outsider, calls her or she calls him/her. To do so, she may drag (arrow 230) a chosen clip, such as clip B, to a screen 239 in personal clip area 208. Community server 130 may distribute chosen clip B at any appropriate time to Jill's telephone or other device.

Jill may also delete clips from her collection; typically by dragging them to a trash can 232 on webpage 200.

In accordance with an alternative preferred embodiment of the present invention, Jill may drag clips directly (arrow 227) from clip directory 202 to buddy area 206. In this embodiment, a purchase request may then pop up, similar to that shown in FIG. 3C, when the selected clip 134 may be dropped into buddy screen area 229.

It will be appreciated that the present invention may be utilized for selecting, purchasing and/or distributing products other than media clips 134. Such a system may be utilized for selecting and purchasing products from an on-line store, library or collection.

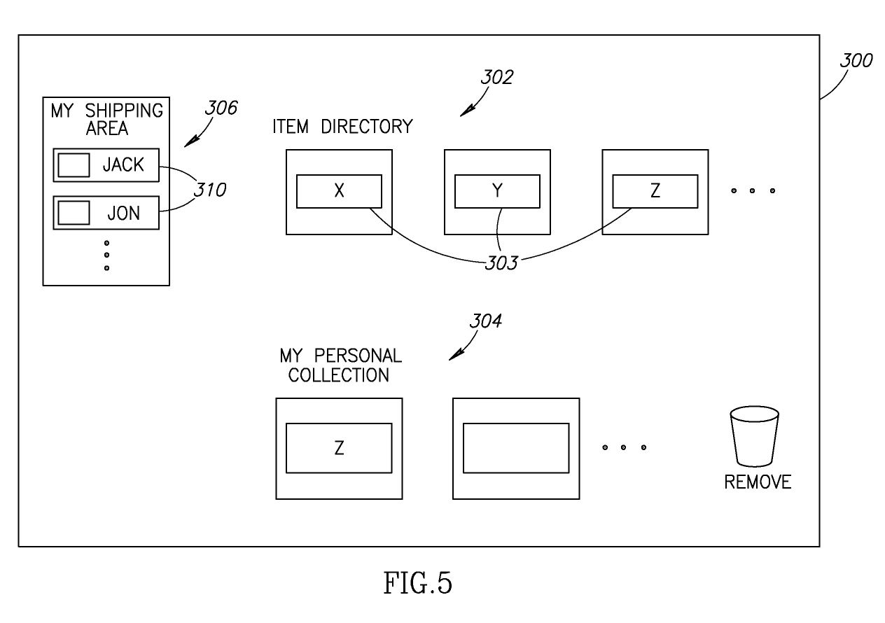

An exemplary webpage 300 for on-line purchasing is shown in FIG. 5, to which reference is now made. Webpage 300 has similar areas as webpage 200. It comprises an item directory 302, which shows images or clips of the items available for selection or purchasing, a personal collection area 304 and a shipping area 306.

As discussed hereinabove, a user merely needs to move a picture, such as pictures X, Y and Z, of a product from item directory 302 into his collection area 304 A purchase request may then pop up, similar to that shown in FIG. 3C.

Webpage 300 may also be utilized to send a purchased product to a friend. For the latter, each friend may be previously defined (for example, their home address and telephone numbers may be previously stored) and listed in shipping area 306. With webpage 300, sending the purchased item to such a friend merely involves dragging a picture of the product stored in personal collection area 304, such as picture Z, to a section, such as section 310, of shipping area 306 related to the friend. If necessary, another request may pop up, similar to the purchase request shown in FIG. 3C, if additional shipping information is necessary and/or if additional payments need to be made. The server for the store may then add the shipping information for the friend to the purchase information. The on-line store may then send the product as it would otherwise.

Alternatively, the ‘friend’ may be a description of any address. It may even store an address of the user. Thus, to ship a purchased item, the user may drag a picture of the product to a section 310 of shipping area 306 related to the described address. Once the picture is dropped into the selected friend section 310 (i.e. once the purchased item has been sent for shipping), the item may be removed from personal collection 304.

In accordance with an alternative preferred embodiment of the present invention, the user may drag a picture of the product directly from item directory 302 to shipping area 306. In this embodiment, a purchase request may then pop up, similar to that shown in FIG. 3C, when picture X, Y or Z may be dropped into section 3 10.

Webpages 200 and 300 may be implemented using Flash technology, commercially available from Adobe Systems Incorporated of the USA. It will be recognized that other standard web programming technologies may be utilized as well.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
enabling a user to drag and drop an item presented on a webpage from a location on said webpage of a public collection to a location on said webpage of a personal collection of said user; and
requesting purchasing information from said user after said item is dropped into said private collection.

2. The method according to claim 1 and wherein said item is a media clip.

3. The method according to claim 2 and wherein said media clip is shared personalization content.

4. The method according to claim 1 and wherein said webpage is associated with an on-line store.

5. The method according to claim 1 and also comprising:
enabling said user to drag and drop said item from said personal collection to a distribution area associated with a selected buddy of said user; and
distributing said item to said selected buddy.

6. The method according to claim 1 and wherein said item is an item to be purchased and also comprising:
enabling said user to drag and drop said item from said personal collection to a distribution area for a labeled shipping address.

7. A method comprising:
having at least one buddy area of a webpage, said buddy area having a distribution area associated with it;
enabling a user to drag and drop an item from a location on said webpage of a personal collection of said user to said distribution area of a selected buddy of said user; and
distributing said item to said selected buddy.

8. The method according to claim 7 and wherein said item is a media clip and said distributing is to a communication device of said buddy.

9. The method according to claim 7 and wherein said item is an item to be purchased and said distribution area is associated with a shipping address of said buddy.

10. A web server comprising:
a web-based application to present items in a public collection area and to enable a user to drag and drop an item from said public collection to a location on said webpage of a personal collection of said user; and
a purchasing application to request purchasing information from said user after said item is dropped into said private collection.

11. The server according to claim 10 and wherein said item is a media clip.

12. The server according to claim 11 and wherein said media clip is shared personalization content.

13. The server according to claim 10 and wherein said webpage is associated with an on-line store.

14. The server according to claim 10 and wherein said web-based application also comprises a shipping application to enable said user to drag and drop said item from said personal collection to a distribution area for a buddy.

15. The server according to claim 14 and wherein said item is a media clip and said shipping application comprises means for distributing said media clip to a communication device of said buddy.

16. The server according to claim 14 and wherein said item is an item to be purchased and said distribution area is associated with a shipping address of said buddy.

17. A server comprising:
a web-based application to enable a user to drag and drop an item from a location on a webpage of a personal collection of said user to a distribution area of a selected buddy of said user; and
a distribution application to distribute said item to said buddy.

18. The server according to claim 17 and wherein said item is a media clip and said distribution application comprises means to send said media clip to a communication device of said buddy.

19. The server according to claim 17 and wherein said item is an item to be purchased and said distribution application comprises means to send said item to a mailing address of said buddy.

20. A method comprising:
having at least one buddy area of a webpage, said buddy area having a distribution area associated with it;
enabling a user to drag and drop an item from a location on said webpage of a public collection to said distribution area of a selected buddy of said user; and
distributing said item to said selected buddy.

21. The method according to claim 20 and wherein said item is a media clip and said distributing is to a communication device of said buddy.

22. The method according to claim 20 and wherein said item is an item to be purchased and said distribution area is associated with a shipping address of said buddy.

23. The method according to claim 20 and also comprising purchasing said item after dropping it.

24. A server comprising:
a web-based application to enable a user to drag and drop an item from a location on a webpage of a public collection to a distribution area of a selected buddy of said user; and
a distribution application to distribute said item to said buddy.

25. The server according to claim 24 and wherein said item is a media clip and said distribution application comprises means to send said media clip to a communication device of said buddy.

26. The server according to claim 24 and wherein said item is an item to be purchased and said distribution application comprises means to send said item to a mailing address of said buddy.
